(19) United States
(12) Patent Application Publication
(10) Pub. No.: US 2024/0362140 A1
(43) Pub. Date: Oct. 31, 2024

(54) DYNAMIC DATASETS MANAGEMENT IN A SENSORS DATA MANAGEMENT SYSTEM

(71) Applicant: INTEMPORA, Issy-les-Moulineaux (FR)

(72) Inventor: Xavier ROUAH, Issy-les-Moulineaux (FR)

(73) Assignee: INTEMPORA, Issy-les-Moulineaux (DE)

(21) Appl. No.: 18/649,411

(22) Filed: Apr. 29, 2024

Related U.S. Application Data
(60) Provisional application No. 63/462,705, filed on Apr. 28, 2023.

(51) Int. Cl. G06F 11/30; G06F 16/245

(52) U.S. Cl. CPC G06F 11/3089; G06F 11/3013; G06F 16/245

(57) ABSTRACT

A dynamic dataset management system enables end users to define a search criteria for sensor data and to request or otherwise specify how much matching sensor data should be collected. For example, an end user may specify a matching dataset list with parameters associated with a driving scenario. The dataset management system receives sensor dataset from data gathering vehicles and sensor datasets that match the search criteria. When sufficient number of matching sensor datasets are gathered, the dataset management system can perform a post processing (e.g., training artificial intelligence network, testing emergency braking algorithm, etc.) using the matching datasets.

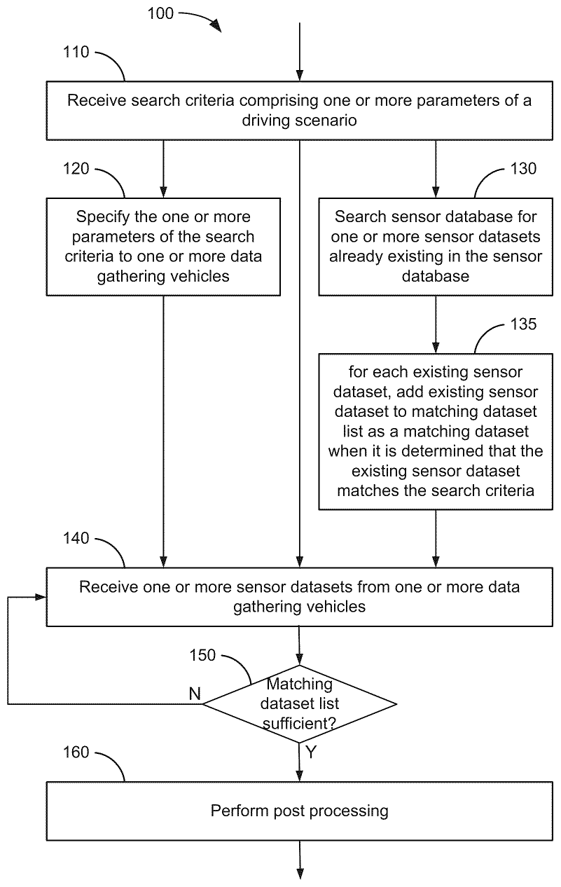

This nonprovisional application claims priority to U.S. Provisional Application No. 63/462,705, which was filed on Apr. 28, 2023, and which is herein incorporated by reference.

### BACKGROUND OF THE INVENTION

### Field of the Invention

The subject matter of the present invention relates—at least in part—to datasets management, and in particular to dynamic datasets management in a sensors data management system.

### Description of the Background Art

To correctly test a given function, a certain amount of test data corresponding to particular situations (e.g., 100 km by night at least in each of the following environments: urban, highway, inter-city, . . . ) should be accumulated. However, it is often difficult to know how many occurrences of a certain situation or which duration or which driving length of a certain situation have been collected so far by data gathering vehicles of a collection fleet and is available in the current data lake or database. It is also often difficult to know how much data is missing compared to the objectives defined for extensive testing purposes.

### SUMMARY OF THE INVENTION

It is therefore an object of the present invention to provide a dataset management system that enables end users to define a search criteria for sensor data and to request or otherwise specify how much matching sensor data should be collected. Any incoming data that matches the search criteria may be saved in a dataset until the amount of matching data are sufficient. Thereafter, post processing (e.g., training, testing, etc.) may be performed on the dataset.

In a first aspect, a method is provided. A data management system may perform the method. The method may comprise receiving search criteria comprising one or more parameters of a driving scenario. The method may also comprise receiving one or more sensor datasets from one or more data gathering vehicles. For each received sensor dataset, the method may further comprise adding the received sensor dataset to a matching dataset list as a matching dataset when it is determined that the received sensor dataset matches the search criteria. The method may further comprise determining whether the matching dataset list is sufficient. In an aspect, the matching dataset list may be deemed sufficient when a number of matching datasets in the matching dataset list is equal to or greater than a matching dataset threshold. The method may yet comprise performing post processing when it is determined that the matching dataset list is sufficient.

U.S. Ser. No. 18/377,612, which is incorporated herein by reference, provides a recording device for a recording of a serialized image data stream from a sensor device, whereby at least the apparatus and method for obtaining data from the sensor is applicable herein.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE illustrates a flow chart of an example method performed by the proposed dataset management system in accordance with one or more aspects of the disclosure.

### DETAILED DESCRIPTION

As indicated, it is proposed to provide a dataset management system that enables end users to define a search criteria for sensor data and to request or otherwise specify how much matching sensor data should be collected. For example, an end user may specify a “matching dataset list” with the following parameters:
Search (e.g., “pedestrians on the road AND night”).
Request a given number of occurrences or a total amount of time (e.g., 1000 occurrences of this event).

After the search criteria have been determined, the one or more data gathering vehicles of the collection fleet may gather sensor data. For each set of incoming sensor data—i.e., incoming sensor dataset-collected by the one or more data gathering vehicles, the sensor dataset may be annotated or otherwise tagged, e.g., by a data collection system. The data collection system may be a part of or separate from the proposed dataset management system. Based on the tags (e.g., day, night, city, highway, pedestrian on the road, pedestrian on the sidewalk, speed limit, etc.), the datasets management system may automatically determine whether the incoming sensor dataset satisfy the search criteria. If so, the sensor dataset may be added to the matching dataset list as a matching dataset. In other words, the matching dataset list may include one or more matching datasets.

The tagged dataset—whether matching or not—may be saved, e.g., in a sensor database. Note that the sensor database, which includes one or more sensor datasets, may exist prior to the search criteria being determined. Then as an alternative or in addition thereto, when the search criteria is determined, the existing sensor database may be searched to determine whether one or more already existing sensor datasets in the sensor database match the search criteria. If so, these may be added to the matching dataset list.

In an aspect, the search criteria may be strictly enforced. That is, if the search criteria includes five (5) parameters, then all five (5) parameters of the search criteria must be matched in order for the sensor dataset to be considered as matching. But in other aspects, the search criteria may be less strictly enforced. For example, a sensor dataset may be considered to be matching if some number of parameters or if some percentage of parameters are matched, then the incoming sensor dataset may be considered as matching.

The dataset management system may keep track of the matching datasets included in the matching dataset list to determine if a sufficient number of the matching datasets have been collected. In an aspect, if the number of matching datasets in the matching dataset list is equal to or greater than a matching dataset threshold (e.g., 1000 in the above example), then it may be determined that the matching dataset is sufficient.

Once a sufficient number of matching datasets have been collected, the dataset management system may automatically launch other processes to utilize the matching datasets in the matching dataset list. In one aspect, the end user or users may be notified that a sufficient number of matching datasets have been collected. Alternatively or in addition thereto, an artificial intelligence (AI) network, such as a neural network, may be trained with the matching datasets list. Still other processes, such as test of emergency braking system, may also be launched.

The data gathering may be streamlined in an aspect. For example, once the search criteria is determined, the search criteria may be specified to the data gathering vehicles. In this way, the data gathering effort maybe targeted. Once a sufficient number of sensor dataset for the search criteria have been gathered, the data gathering vehicles may be notified as such. In this way, further data gathering efforts—which may not be necessary—can cease.

Of course, it is contemplated data gathering efforts for the search criteria can continue even though the matching dataset list is deemed sufficient. For example, it may be that a minimum of 1000 matching datasets are necessary to train the AI network to achieve a reasonable accuracy. But if more than the minimum is available for training, the accuracy of the AI network can improve.

However, it can be that the utility of the next matching dataset is diminished relative to the previous matching dataset. Then it can be that when some total number of matching datasets have been collected, then the benefit (e.g., increase in accuracy) of each additional matching dataset may not be worth the cost (e.g., time, money, etc.) of acquiring that additional matching dataset.

In this context, two or more thresholds may be set. For example, the matching dataset threshold discussed above may be a first matching dataset threshold that specifies a minimum number of matching datasets necessary to perform a process, such as training the AI network, test the emergency braking system, etc. Then a second matching dataset threshold that specifies a maximum number of matching datasets to be collected. When the second matching dataset threshold is met, the data gathering activities for the search criteria can cease.

The FIGURE illustrates a flow chart of an example method 100 performed by the proposed dataset management system.

In block 110, the dataset management system may receive a search criteria, e.g., from an end user. The search criteria may comprise one or more parameters, e.g., of a driving scenario.

In one aspect, the method 100 may proceed directly to block 140 from block 110.

Alternatively, or in addition thereto, the method 100 may proceed to block 120 from block 110. In block 120, the dataset management system may specify the one or more parameters of the search criteria to the one or more data gathering vehicles. Thereafter, the method 100 may then proceed to block 140.

Also alternatively or in addition thereto, the method 100 may proceed to block 130 from block 110. In block 130, the dataset management system may search a sensor database for one or more sensor datasets already existing in the sensor database. Then in block 135, the dataset management system may, for each existing sensor dataset, add the existing sensor dataset to the matching dataset list as a matching dataset when it is determined that the existing sensor dataset matches the search criteria. Thereafter, the method 100 may then proceed to block 140.

In block 140, the dataset management system may receive on or more datasets from one or more data gathering vehicles.

In block 150, the dataset management system may determine whether the matching dataset list is sufficient.

If it is determined that the matching dataset list is not sufficient (‘N’ branch from block 150), the method 100 may proceed back to block 140.

On the other hand, if it is determined that the matching dataset list is sufficient (‘Y’ branch from block 150), then in block 160, the dataset management system may perform post processing on the matching dataset list. For example, the end user may be notified, and the matching dataset list may be made available for processing by the end user. In another example, AI network training may take place with the matching dataset list. In another example, a vehicle function, such as testing of an emergency braking algorithm, may be tested.

While not shown, the dataset management system may be implemented in a variety of ways. In one aspect, the dataset management system may be implemented in a computing device comprising one or more processors and storage system (e.g., RAM, ROM, disk, flash, etc.). In another aspect, the dataset management system may be implemented in a group of computing devices communicating over a communication network (e.g., ethernet, internet, LAN, etc.).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method, comprising:
receiving search criteria comprising one or more parameters of a driving scenario;
receiving one or more sensor datasets from one or more data gathering vehicles; for each received sensor dataset, adding the received sensor dataset to a matching dataset list as a matching dataset when it is determined that the received sensor dataset matches the search criteria;
determining whether the matching dataset list is sufficient, the matching dataset list being deemed sufficient when a number of matching datasets in the matching dataset list is equal to or greater than a matching dataset threshold; and
performing post processing when it is determined that the matching dataset list is sufficient.

2. The method of claim 1, wherein the sensor data are received from the one or more data gathering vehicles subsequent to receiving the search criteria.

3. The method of claim 1, further comprising:
specifying, subsequent to receiving the search criteria, the one or more parameters of the search criteria to the one or more data gathering vehicles.

4. The method of claim 1, further comprising:
searching, subsequent to receiving the search criteria, a sensor database for one or more sensor datasets already existing in the sensor database; and
for each existing sensor dataset, adding the existing sensor dataset to the matching dataset list as a matching dataset when it is determined that the existing sensor dataset matches the search criteria.

5. The method of claim 1, further comprising:
notifying, when it is determined that the matching dataset list is sufficient, the one or more data gathering vehicles that a sufficient amount of sensor data associated with the search criteria has been acquired.

6. The method of claim 1, wherein the post processing comprises training an artificial intelligence network with the matching dataset list.

7. The method of claim 1, wherein the post processing comprises testing a vehicle function with the matching dataset list.

8. The method of claim 7, wherein the vehicle function is an emergency braking algorithm.
